(19) United States
(12) Patent Application Publication
(10) Pub. No.: US 2004/0089407 A1
(43) Pub. Date: May 13, 2004

(54) Methods and apparatus for applying images to components

(76) Inventor: Stephen Joseph Halewood, Surrey (GB)

Correspondence Address: CHRISTIE, PARKER & HALE, LLP, 350 WEST COLORADO BOULEVARD, SUITE 500, PASADENA, CA, 91105, US

(21) Appl. No.: 10/467,814

(22) PCT Filed: Jan. 21, 2002
(86) PCT No.: PCT/GB02/00245

(30) Foreign Application Priority Data
Feb. 13, 2001 (GB) 0103467.7

(51) Int. Cl. B05D 5/00; B44C 1/165; B05D 3/12; B32B 31/00

(52) U.S. Cl. 156/230; 156/540; 156/581

(57) ABSTRACT

A method of applying a heat fixable ink image to a moulded thermoplastic component involves applying an image to carrier sheet, applying the carrier sheet to the component to conform to the surface contours thereof and then heating the image to a temperature below that temperature at which the image will satisfactorily transfer to the component. A pressure of such magnitude and duration is then applied to the image through a pair of mating dies of complementary shape to the component as to then cause the image to tansfer to the component to become permanently fixed thereto.

The present invention relates to methods and apparatus for applying images to components.

Images such as pictures, photographs and printed matter are often applied to the outer surfaces of rigid components such as metal casings for instruments and the like. These images are applied as paints, inks, dyes and decalcomania. When the surface is other than planar, the images are first applied to a carrier sheet which is then pressed against the surface of the component, with the image located between the component and the sheet, so as to cause the sheet, and therefore the image, to conform to the contours of the surface. The image is then caused to transfer, at least in part, to the surface of the component and become fixed thereto by the application of heat to a temperature often in excess of 200° C. A residual amount of the image will remain on the carrier sheet.

However, many instrument casings such as mobile phone casings are made of engineering thermoplastics which if heated to temperatures in excess of 140° C., have a tendency to distort or start to melt which may not only result in a distortion of the image but also engender a mismatch with other components that the casing interacts with. Using temperatures lower than 180° C. means that the images are not satisfactorily transferred.

It is an object of the invention to provide an improved method and apparatus for applying images to components.

According to the present invention there is provided a method of applying an image to a moulded thermoplastics component comprising the steps of depositing a heat fixable image on the surface of a carrier, sandwiching the component and the carrier with the deposited image facing the component, between a pair of dies of complementary shape to the component, subjecting the image on the component to a temperature below that at which the image will satisfactorily transfer to the component in the absence of pressure, and operating the dies to apply pressure to the image and component of sufficient magnitude and duration to cause a satisfactory transfer of the image to the component.

According to the present invention there is further provided apparatus for at least partially transferring an image from a carrier to a moulded thermoplastics component comprising a press having mating dies of complementary shape to the component, means for heating at lest one the die and control means for controlling the pressure, temperature and duration of application of the temperature and pressure to the image and component such that (a) the temperature lies below that at which the image will be satisfactory transfer to the component absent any substantial pressure, and (b) the pressure and duration are respectively of sufficient magnitude and duration to cause the image to satisfactorily migrate or defuse into the surface of the component.

Methods and apparatus for apply images to components will now be described, by way of example, with reference to the accompanying diagrammnatic drawings, in which:

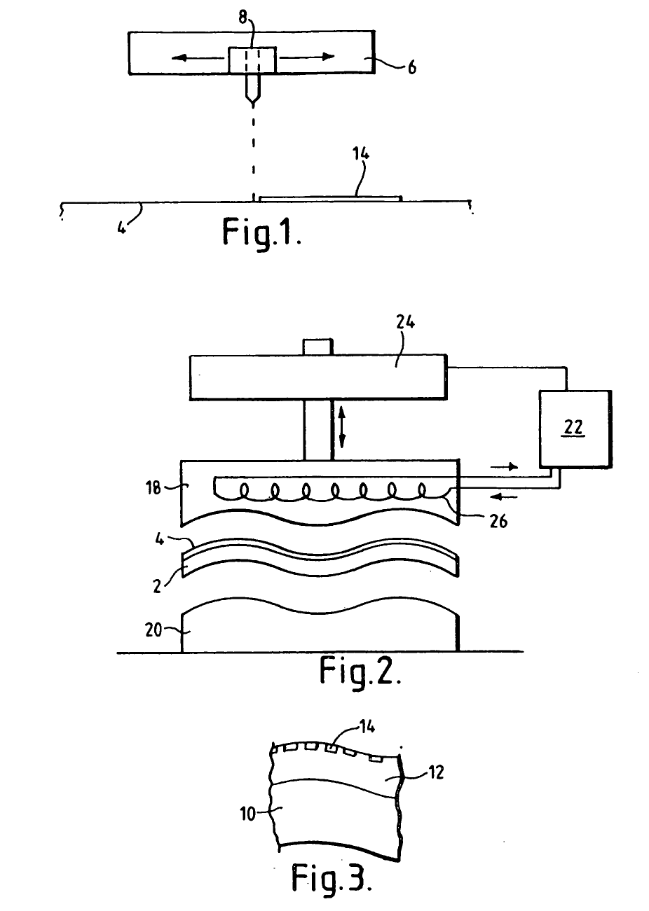

FIG. 1 is a front elevation of an inkjet nozzle assembly mounted to progressively deposit an image on a carrier sheet;

FIG. 2 is a front elevation of the mobile phone housing and a carrier sheet carrying the image, mounted in a heated press; and

FIG. 3 is a fragmentary cross-section to an enlarged scale of the housing.

FIG. 1 shows a carrier sheet 4 positioned below a support 6 carrying a scanning inldet nozzle assembly 8 which can progressively deposit an inkjet image 14 on the upper surface of the carrier sheet 4. Instead a dye sublimation printer can be used. The carrier sheet 4 is then applied to the outer surface of a mobile phone housing 2, which may be the back or front half as required.

The coated housing 2, as shown in FIG. 3, comprises a substrate 10 of moulded plastics and an outer lacquer layer 12 bonded to the substrate which in turn carries the ink image 14.

The plastics substrate 10 can comprise polypropylene, polyester, polyamide, Acrylonitrile Butadene Styrene (ABS), polycarbonate, Polyetherester Ketones (PEEK), Polyethersulfone (PES), polyimide, polyaryl and derivatives and mixtures of the above. In fact, any engineering thermoplastics with a Heat Distortion Temperatures (HDT) at a pressure of 0.46 MPa of a minimum of 100° C. can be used.

The lacquer can be any topcoat manufactured from a thermosetting base polymer including polyester, polyacrylic, polyurethane or an epoxy resin.

Once the image has been formed on the carrier sheet 4, the carrier sheet 4 and the housing 2 are placed in a heated press 16 having an upper die 18 and a lower die 20 of complementary shape to the housing 2. The upper die 18 is then driven towards the lower die 20 until the housing 2 and carrier sheet are firmly clamped between them. The dye 18, which may then be heated or preheated, subjects the image 14 to a temperature in the range of from 110° C. to 180° C. but preferably in the range of from 140° C. to 170° C. The dies 18 and 20 are then driven to apply a very high pressure to the housing 2 in the range of from 8 to 60 Kg/cm² but preferably in the range of from 26 to 40 Kg/cm².

This high pressure and low temperature are sustained for a period in the range of 25 to 600 seconds but preferably in the range of from 100 to 200 seconds depending upon the magnitude of the pressure and temperature; higher temperatures and higher pressure requiring less time than lower temperatures and pressures. It is important that excessive times should not be used otherwise the ink of the image is likely to migrate or diffuse sideways into the lacquer layer to such an extent as to produce a blurred image. Approximately 50% of the image is transferred to the component with the residue remaining on the carrier.

While normal temperatures of 110° C. to 170° C. could not cause a satisfactory and sufficient transfer of the image 14 to the housing, the very high pressures reached surprisingly act to cause an effective and sufficient transfer of the image to fix it permanently to the housing. The image 14 in effect migrates or diffuses into the lacquer layer. Because the dies 28 and 20 have a complementary shape to the housing 2, the shape of the housing remains undistorted by the process and so can bear an undistorted image and after the image has been fixed can properly engage complementary components.

Control means 22 are connected to a drive for the upper die 18 to control the amplitude and duration of the pressure applied by the die 18 to the housing 2. The control means 22 is also connected to electrical or a fluid heat transfer heating element 26 in the die 18, to control the magnitude and duration of the heat supplied to the housing 2.

The dies 18 and 20 may be of polished metal or metal alloy or coated with a layer of material to which the images will not adhere at the temperatures and pressures used.

1. A method of applying an image to a moulded thermoplastics component comprising the steps of depositing a heat fixable image on the surface of a carrier, sandwiching the component and the carrier with the deposited image facing the component, between a pair of dies of complementary shape to the component, subjecting the image on the component to a temperature below that at which the image will satisfactorily transfer to the component in the absence of pressure, and operating the dies to apply pressure to the image and component of sufficient magnitude and duration to cause a satisfactory transfer of the image to the component.

2. A method according to claim 1, wherein the component comprise a plastics selected from the following: polypropylene, polyester, polyamide, ABS, polycarbonate, PEEK, PES, polyimide, polyaryl and derivatives and mixtures of these or an engineering thermoplastic with a heat distortion temperature at a pressure of 46 MPa greater than 100° C.

3. A method according to claim 1 or to claim 2, wherein the surface of the component on which the image is deposited comprises a lacquer layer.

4. A method according to claim 3, wherein the lacquer layer comprises a thermosetting base polymer.

5. A method according to claim 4, wherein the thermosetting base polymer comprises one of the following: polyester, polyacrylic, polyurethane or an epoxy resin.

6. A method according to any preceding claim, wherein the step of subjecting the component to a temperature comprises subjecting the image and the component to a temperature in the range of from 110° C. to 180° C.

7. A method according to any one of claims 1 to 5, wherein the step of subjecting the image to a temperature comprises subjecting the image on the carrier to a temperature in the range of from 140° C. to 170° C.

8. A method according to any preceding claim, wherein the step of subjecting the image and the component to a pressure comprises subjecting the image and the component to a pressure in the range of from 8 to 60 Kg/cm².

9. A method according to any one of claims 1 to 7, wherein the step of subjecting the image and component to a pressure comprises subjecting the image and the component to a pressure in the range of from 26 to 40 Kg/cm².

10. A method according to any preceding claim, wherein said duration lies in the range of from 25 to 600 seconds.

11. A method according to any one of claims 1 to 9, wherein said duration lies in the range of from 100 to 200 seconds.

12. Apparatus for at least partially transferring an image from a carrier to a moulded thermoplastics component comprising a press having mating dies of complementary shape to the component, means for heating at lest one the die and control means for controlling the pressure, temperature and duration of application of the temperature and pressure to the image and component such that (a) the temperature lies below that at which the image will be satisfactory transfer to the component absent any substantial pressure, and (b) the pressure and duration are respectively of sufficient magnitude and duration to cause the image to satisfactorily migrate or defuse into the surface of the component.
